(19) United States
(12) Patent Application Publication
(10) Pub. No.: US 2015/0150120 A1
(43) Pub. Date: May 28, 2015

(54) SYSTEM AND METHOD FOR UNLOCKING TOUCH SCREEN AND TOUCH INPUT ELECTRONIC DEVICE THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventor: GANG-HUA LIU, Shenzhen (CN)

(21) Appl. No.: 14/524,522

(22) Filed: Oct. 27, 2014

(30) Foreign Application Priority Data
Nov. 26, 2013 (CN) 201310605756.4

(51) Int. Cl. G06F 21/36; G06F 3/0482; G06F 3/0484; G06F 3/0481

(52) U.S. Cl. CPC G06F 21/36; G06F 3/04817; G06F 3/0482; G06F 3/04847
USPC 726/19

(57) ABSTRACT

A touch input electronic device, an unlocking system and method are provided. An unlocking interface is displayed on a touch screen of the touch input electronic device. The interface can include a slidable unlocking icon and a number of icons. Each icon displays a content item. Each time when a user slides the unlocking icon to one of the icon, the content item in the icon is determined, and an arrangement of the icons is changed. After the user input is finished, an unlock password is determined according to an input sequence of the content items. The touch screen is unlocked when the unlock password matches a per-stored password.

### CROSS-REFERENCE TO RELATED APPLICATIONS

This application claims priority to Chinese Patent Application No. 201310605756.4 filed on Nov. 26, 2013, the contents of which are incorporated by reference herein.

### FIELD

The subject matter herein generally relates to systems, devices, and methods for unlocking touch screens.

### BACKGROUND

Touch input electronic devices are widely used. For safety and power saving, a touch screen of the touch input electronic device would be locked if the user does not operate the touch input electronic device. When the user want to use the touch input electronic device again, the user first needs to unlock a touch screen of the touch input electronic device. A usual method to unlock the touch screen is to input a preset password.

### BRIEF DESCRIPTION OF THE DRAWINGS

Implementations of the present technology will now be described, by way of example only, with reference to the attached figures.

FIG. 1 is a block diagram illustrating an example embodiment of an touch input electronic device.

FIG. 2 is a diagrammatic illustration of example embodiments showing a first state of an unlocking interface when unlocking a touch input electronic.

FIG. 3 is a diagrammatic illustration of example embodiments showing a second state of the unlocking interface of FIG. 2.

FIG. 4 is a diagrammatic illustration of example embodiments showing a third state of the unlocking interface of FIG, 2.

FIG. 5 is a flow chart illustrating an example embodiment of an unlocking method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein, However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

Several definitions that apply throughout disclosure will now be presented. The term “module” refers to logic embodied in computing or firmware, or to a collection of software instruction, written in a programming language, such as Java, C, or assembly. One or more software instruction in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “coupled” is defined as connected, whether directly or indirectly through intervening components, and is not necessarily limited to physical connections. The connection can be such that the objects are permanently connected or releasably connected. The term “comprising” means “including, but not necessarily limited to”, it specifically indicates open-ended inclusion or membership in a so-described combination, group, series and the like.

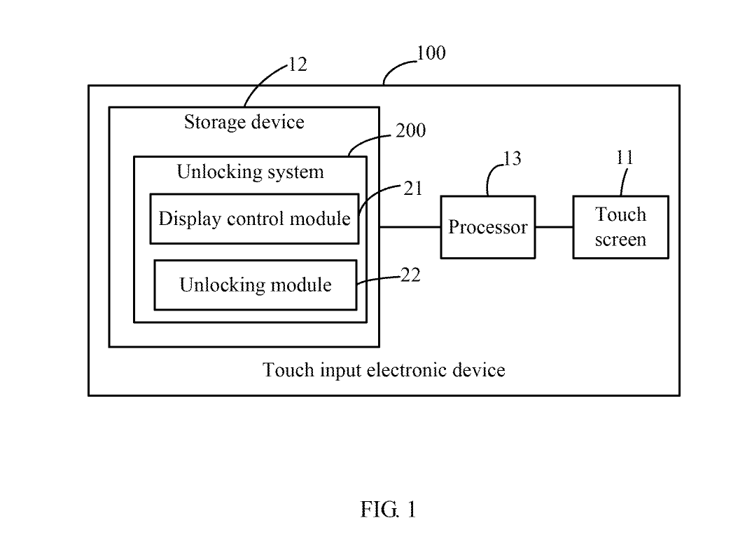

FIG. 1 illustrates a block diagram of a touch input electronic device 100. The touch input electronic device 100 can be a mobile phone, a tablet computer, and the like. In at least one embodiment, the touch input electronic device 100 can include a touch screen 11, a storage device 12, and a processor 13. The touch screen 11 and the storage device 12 are coupled to the processor 13. In one embodiment, the processor 13 can be a central processing unit, a digital signal processor, or a single chip, for example. The storage device 12 is coupled to the processor 13. The storage device 12 can be an internal storage system, such as a flash memory, a random access memory (RAM) for temporary storage of information, and/or a read-only memory (ROM) for permanent storage of information. The storage device 12 can also be a storage system, such as a hard disk, a storage card, or a data storage medium. The storage device 12 can include volatile and/or non-volatile storage devices. In at least one embodiment, the storage device 12 can include two or more storage devices such that one storage device is a memory and the other storage device is a hard drive. Additionally, one or more of the storage devices 12 can be located either entirely or partially external relative to the touch input electronic device 100.

In this embodiment, a screen unlocking system 200 can be stored in the storage device 12. The screen unlocking system 200 can include a number of modules, which are collection of software instructions stored in the storage device 12 and executed by the processor 13. In at least one embodiment, the screen unlocking system 200 can include a display control module 21 and an unlocking module 22.

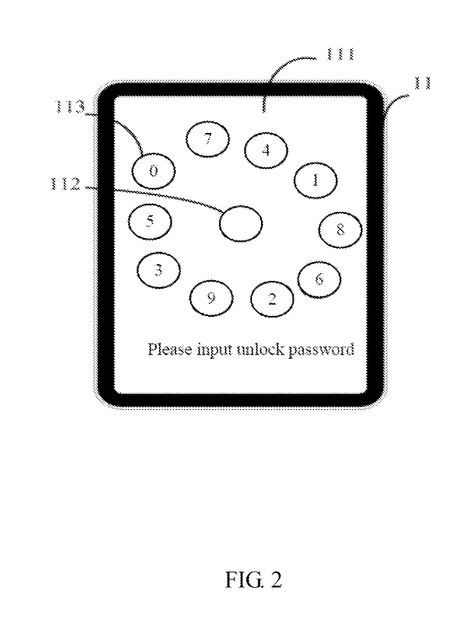

The display control module 21 is used to control the touch screen 11 to display an unlocking interface 111 in response to an unlock trigger signal generated by user operation. For example, when the user wants to unlock the touch input electronic device 100, the user can operate a mechanical button (such as a power button) of the touch input electronic device 100 to generate the unlock trigger signal. As shown in FIG. 2, the unlocking interface 111 can include a slidable unlock icon 112 and a number of icons 113. The arrangement of the icons 113 are randomly. Each icon 113 displays one content item, and the content items displayed in the icons are different from each other. In this embodiment, the slidable unlock icon 112 is surrounded by the number of the icons 113. In this embodiment, an amount of the icons 113 is ten, and each content item displayed in the icons 113 is one of numerals from 0 to 9. In other embodiments, each content item further can be a letter, a character, a pattern, and the like.

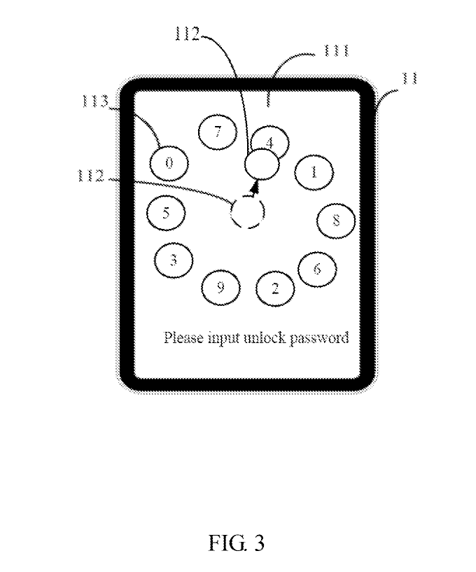

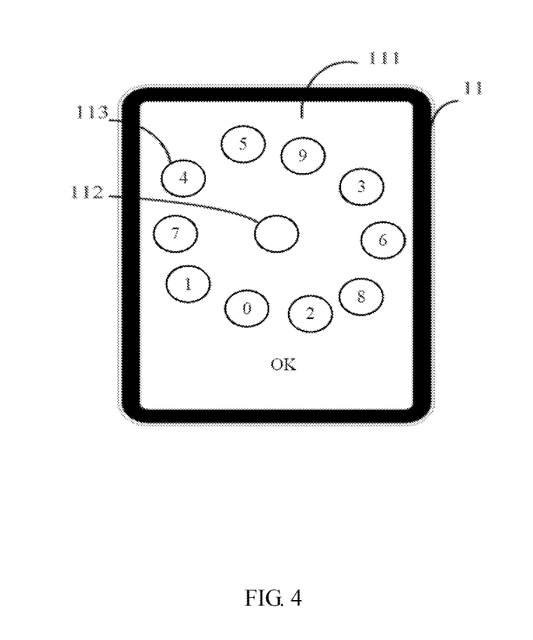

As shown in FIG. 3, after the unlocking interface 111 is displayed, when a user needs to unlock the touch screen 11, the user can slide the slidable unlock icon 112 to one of the icons 113 to input one bit of an unlock password. In other words, the slidable unlock icon 112 is slid to the position of the one of the icons 113 to input the bit of the unlock password. Each time when the user slides the slidable unlock icon 112 to one of the icons 113, the display control module 21 changes the arrangement of the icons 113 randomly, as shown as FIG. 4. That is, when the user inputs a bit of the unlock password, the arrangement of the content items in the icons 113 are different from the arrangement of the content items when inputting a previous bit of the unlock password.

Each time when the user slides the slidable unlock icon 112 to one of the icons 133, the unlocking module 22 obtains the content item displayed in the icon 133 which the slidable unlock icon 112 slides to. After the user input is finished, the unlocking module 22 combines the obtained content items according to an input sequence of the content items to determines the unlock password input by the user. In this embodiment, the unlocking module 22 determines the user input is finished if the unlocking module 22 determines that there is no user input for a predetermined time period, such as three seconds. The unlocking module 22 further determines whether the determined unlock password matches a per-stored password. If the unlocking module 22 determines that the determined unlock password matches the per-stored password, the unlocking module 22 unlocks the touch screen 11.

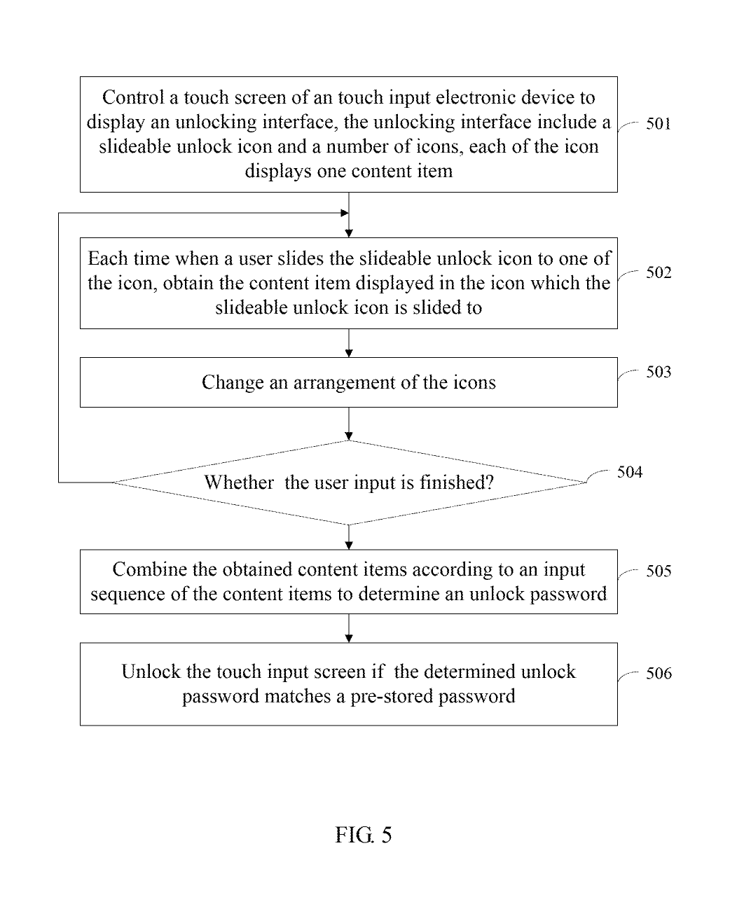

FIG. 5 illustrates an embodiment of a unlocking method applied in a touch input electronic device. The method is provided by way of example, as there are a variety of ways to carry out the method. The method described below can be carried out using the configurations illustrated in FIG. 1, for example, and various elements of these figures are referenced in explaining the example method. Each block shown in FIG. 5 represents one or more processes, methods, or subroutines carried out in the example method. Additionally, the illustrated order of blocks is by example only and the order of the blocks can be changed. The example method can begin at block 501.

At block 501, a display control module controls a touch screen of an touch input electronic device to display an unlocking interface, the unlocking interface can include a slidable unlock icon and a number of icons, each of the icon displays one content item, the content items in different icons are different.

At block 502, each time when a user slides the slidable unlock icon to one of the icon, an unlocking module obtains the content item displayed in the icon which the slidable unlock icon slides to.

At block 503, the display control module controls the arrangement of the icons to change.

At block 504, the unlocking module determines whether the user input is finished. If the unlocking module determines that the user input is finished, the procedure goes to block 505, otherwise, the procedure goes back to block 502.

At block 505, the unlocking module combines the obtained content items according to an input sequence of the content items to determine an unlock password.

At block 506, the unlocking module unlocks the touch input screen if the unlocking module determines that the determined unlock password matches a pre-stored password.

The embodiments shown and described above are only examples. Many further details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A touch input electronic device comprising:
a processor;
a storage device coupled to the processor;
a touch screen coupled to the processor;
a display control module, stored in the storage device, comprising at least one instruction configured to cause the processor to control the touch screen to display an unlocking interface, the unlocking interface comprising at least one slidable unlock icon and a plurality of icons, each of the icons displaying one content item, wherein each time a user slides the slidable unlock icon to the position of one of the icons, the display control module causes the processor to change an arrangement of the icons; and
an unlocking module, stored in the storage device, comprising at least one instruction configured to cause the processor to obtain the content item displayed in the icon which the slidable unlock icon slides to; combine the content items obtained by the unlocking module according to an input sequence of the content items to determine an unlock password; and unlock the touch screen if the determined unlock password matches a pre-stored password.

2. The touch input electronic device of claim 1, wherein the slidable unlock icon is surrounded by the plurality of the icons.

3. The touch input electronic device of claim 1, wherein the content items in the icons are different from each other.

4. The touch input electronic device of claim 1, wherein each content item displayed in the icon is one of numerals from 0 to 9.

5. The touch input electronic device of claim 1, wherein the content items are letters or characters.

6. The touch input electronic device of claim 1, wherein the arrangement of the icons is randomly.

7. An unlocking method applied in a touch input electronic device, the touch input electronic device comprising a touch screen and a processor, the method comprising:
controlling the touch screen of the touch input electronic device to display an unlocking interface by the processor, wherein the unlocking interface comprises a slidable unlock icon and a number of icons, each of the icon displays one content item;
each time when a user slides the slidable unlock icon to the position of one of the icon, obtaining the content item displayed in the icon which the slidable unlock icon slides to by the processor;
changing an arrangement of the icons by the processor;
combining the obtained content items according to an input sequence of the content items to determine an unlock password; and
unlocking the touch input screen if the unlock password matches a determined password.

8. The unlocking method of claim 7, wherein the slidable unlock icon is surrounded by the plurality of the icons.

9. The unlocking method of claim 7, wherein each content item displayed in the icon is one of numerals from 0 to 9.

10. The unlocking method of claim 7, wherein the content items in the icons are different from each other.

11. The unlocking method of claim 7, wherein the content items are letters or characters.

12. The unlocking method of claim 7, wherein the arrangement of the icons is randomly.

13. An unlocking system applied in a touch input electronic device, the touch input electronic device comprising a storage device, a touch screen and a processor, the unlocking system comprising:
a display control module, stored in the storage device, comprising at least one instruction configured to cause the processor to controls the touch screen to display an unlocking interface, the unlocking interface comprising at least one slidable unlock icon and a plurality of icons, each of the icon displays one content item, each time when a user slides the slidable unlock icon to the position of one of the icons, the display control module cause the processor to change an arrangement of the icons; and
an unlocking module, stored in the storage device, comprising at least one instruction configured to cause the processor to obtain the content item displayed in the icon which the slidable unlock icon slides to, combine the content items obtained by the unlocking module according to an input sequence of the content items to determine an unlock password, and unlock the touch screen if the determined unlock password matches a pre-stored password.

14. The unlocking system of claim 13, wherein the slidable unlock icon is surrounded by the plurality of the icons.

15. The unlocking system of claim 13, wherein each content item displayed in the icon is one of numerals from 0 to 9.

16. The unlocking system of claim 13, wherein the content items are letters or characters.

17. The unlocking system of claim 13, wherein the arrangement of the icons is randomly.

18. The unlocking system of claim 13, wherein the content items in the icons are different from each other.
